(19) United States
(12) Patent Application Publication
(10) Pub. No.: US 2016/0336824 A1
(43) Pub. Date: Nov. 17, 2016

(54) Stator Disc and Axial Flux Permanent Magnet Apparatus

(71) Applicants: Hubei Haishan Technology Co., Ltd. Shanghai Branch, Shanghai (CN); Zhuhai Sharp-Group Enterprise Co., Ltd., Zhuhai City, Guangdong (CN)

(72) Inventors: Jianhua DUAN, Shanghai (CN); Xiaoqing WU, Shanghai (CN); Xiaofel YANG, Guangdong Province (CN); Fei ZHOU, Shanghai (CN); Wei ZHAO, Shanghai (CN)

(73) Assignee: Hubei Haishan Technology Co., Ltd., Hubei Provine (CN)

(21) Appl. No.: 15/106,459

(22) PCT Filed: Dec. 18, 2014
(86) PCT No.: PCT/CN2014/094195

§ 371 Date: Jun. 20, 2016

(30) Foreign Application Priority Data
Dec. 20, 2013 (CN) 201310716726.0

(51) Int. Cl. H02K 3/26; H02K 21/24

(52) U.S. Cl. CPC H02K 3/26; H02K 21/24

(57) ABSTRACT

The present disclosure describes a stator disc and an axial-flux permanent magnet kinetic energy device. The stator disc comprises: a substrate (110), a plurality of windings (120); at least one connecting conductor (130); and at least one current-terminal connection conductor (140); wherein: the substrate is provided with an axle hole (111); the at least one connecting conductor is formed in the substrate; all or some of the plurality of the windings are independent of one another, disposed on the substrate, and all or partially connected via the at least one connecting conductor; and the at least one current-terminal connection conductor is formed in the substrate to connect one of the plurality of the windings and a phase current.

### TECHNICAL FIELD

The present disclosure relates to the technical field of electric equipment, in particular, stator disc and axial-flux permanent magnet devices.

### BACKGROUND

In a coreless-stator axial-flux permanent magnet (AFPM) motor, according to the principle of electromagnetic induction, a magnetic field may be generated around an electrified conductor, and a rotating magnetic field may be generated when a phase current flows through windings of the stator (rotating magneto-motive force). The rotor's main magnetic pole produced by the permanent magnet rotor is equivalent to a magnet, and a stator-rotating magnetic field attracts the permanent magnet rotor to rotate in a direction of the rotating magnetic field, thus realizing motor running. Because the axial-flux permanent magnet motor has no iron core, an iron-core loss may therefore be avoided. The iron core loss (for short, “iron loss,” also called “magnetic core loss” or “excitation loss”) is a power loss caused by alternating or pulsating magnetic field in the magnetic material, which is in a form of heat, including a magnetic hysteresis loss and an eddy-current loss. Compared with conventional motors, it is featured with higher running efficiency as well as a small volume, light weight, high power density, excellent control performance, and easy manufacturing, etc. In addition, the axial-flux permanent magnet motor may also be configured through different quantities of stator discs and permanent magnetic rotors to meet various power requirements. Therefore, axial-flux permanent magnet motors have broad application prospects.

However, since an axial-flux permanent magnet motor has a small air gap, its stator disc needs to be thin and flat in order to improve its electrical characteristics.

Currently, there are mainly two kinds of manufacturing methods for a stator disc, namely, a coil-winding stator disc, and a printed circuit board (“PCB”) stator disc.

For the coil-winding stator disc, as the coils are connected through winding the coils continuously or through welding between conductors, batch production efficiency is low. Furthermore, when the stator disc is manufactured, the connecting wires between the coils at inner and outer peripheries may overlap with the coils. As a result, the overlapping part becomes evidently thicker and the stator disc becomes uneven. In addition, only small-diameter coils can be used, which results in lower power of the motor.

For the PCB stator disc, such as that disclosed in U.S. Pat. No. 7,109,625, which involves a kind of optimized axial field rotational energy device used in motors that may convert electric energy into mechanical energy or used in power generators that may convert mechanical energy into electric energy. The stator disc disclosed therein accomplishes pre-set power and efficiency by stacking multiple circuit layers on which multiple electronic components are disposed. Because the stator disc used therein is manufactured by PCB manufacturing process, the active conductor wires for cutting magnetic lines are printed on the circuit board, the wire diameter is therefore limited greatly. To reach the pre-set power, a multi-layer circuit board is needed, and may only be used in lower-power motors. In addition, the manufacturing cost is high.

### SUMMARY

In view of the above, the present disclosure is to solve the technical problems in conventional axial-flux permanent magnet motors or power generators, such as uneven stator discs, small wire diameters, small power, complicated processes, and high manufacturing cost, etc.

The present disclosure provides a stator disc that comprises a substrate, a plurality of windings, at least one connecting conductor, and at least one electric current-terminal connection conductor, wherein: the substrate is provided with an axle hole; the at least one connecting conductor is formed in the substrate; all or some of the windings are independent of one another and located on the substrate; the windings independent of one another are all or partially connected through the connecting conductors; and the at least one current-terminal connection conductor is formed in the substrate and connects one of the windings to a phase current.

Furthermore, the aforesaid windings include a first winding side and a second winding side that are laid out in a radial direction along the axle hole.

Furthermore, the windings are arranged in a radial direction around the axle hole.

Furthermore, these windings are independent coils.

Furthermore, the wire diameter of the coil is 0.25-1.5 millimeters (mm), and the windings for each current phase have 16-70 turns in total.

Furthermore, the substrate is single-sided, and these windings are disposed on one side of the substrate.

Furthermore, the substrate is double-sided, and the windings are on both sides of the substrate, respectively.

Furthermore, the substrate includes: a first via hole running through the substrate and connected to the at least one connecting conductor, and a second via hole running through the substrate and connected to the at least one current-terminal connection conductor. The first and second via holes are used to connect all or some of the windings on the substrate.

Furthermore, there may be two or more substrates, which are arranged in an overlaying mode.

The present disclosure also provides an axial-flux permanent magnet apparatus, comprising multiple rotors with multiple permanent magnetic poles, and a stator disc as disclosed above.

Furthermore, the multiple rotors are disposed on both sides of the stated stator disc respectively, so that the permanent magnetic poles have their field directions perpendicular to the stator disc.

Furthermore, the axial-flux permanent magnet apparatus is 50-5000 watts in power.

In sum, in the stator disc and axial-flux permanent magnet apparatus disclosed herein, each winding used in the stator disc is an independent single-coil and does not require multiple coils wound continuously, and therefore the manufacturing process is simpler and with higher production efficiency. The substrate used to fix and connecting the windings uses a simple, low-cost, single-sided or double-sided design. Multiple single-coil windings, components, and sockets connected with controllers are welded on the substrate. The installation process is simple.

Second, the substrate is used to connect, install, and fix the winding coils, and install and connect other electronic components and connectors, and can avoid overlapping between connecting wires and winding coils, effectively reducing thickness of the stator disc and ensuring its flatness. At the same time, the power, power density, and efficiency of the motor may be enhanced by increasing wire diameters of the winding coils or the number of substrates that are equipped with multiple windings.

### BRIEF DESCRIPTION OF THE DRAWINGS

FIG. 1 shows a schematic view of a stator disc structure according to one embodiment of the present disclosure.

FIG. 2 shows a schematic view of a winding according to one embodiment of the present disclosure.

FIG. 3 shows a schematic view of a stator disc according to another embodiment of the present disclosure.

FIG. 4 shows an axial-flux permanent magnet apparatus according to one embodiment of the present disclosure.

FIG. 5A shows a front schematic view of the structure of a single-current-phase stator disc according to one embodiment of the present disclosure.

FIG. 5B shows a rear schematic view of the structure of a single-current-phase stator disc according to one embodiment of the present disclosure.

FIG. 5C shows a schematic view of a single-current-phase single-sided stator disc according to one embodiment of the present disclosure.

FIG. 5D shows a schematic view of a single-current-phase single-sided stator disc according to another embodiment of the present disclosure.

FIG. 6A shows a front schematic view of the structure of a two-current-phase stator disc according to another embodiment of the present disclosure.

FIG. 6B shows a rear schematic view of the structure of a two-current-phase stator disc according to another embodiment of the present disclosure.

FIG. 6C shows a schematic view of a two-current-phase single-sided stator disc according to one embodiment of the present disclosure.

FIG. 7A shows a front schematic view of the structure of a three-current-phase stator disc according to another embodiment of the present disclosure.

FIG. 7B shows a rear schematic view of the structure of a three-current-phase stator disc according to another embodiment of the present disclosure.

FIG. 7C shows a schematic view of a three-current-phase single-sided stator disc according to one embodiment of the present disclosure.

### DETAILED DESCRIPTION

To facilitate the understanding of the objectives and characteristics of this disclosure, the specific embodiments of this disclosure will be further explained below with reference to the enclosed drawings.

The conventional axial-flux permanent magnet motors and or power generators have some technical limitations such as uneven stator discs, small conductor diameters, small power, complicated manufacturing processes, and high manufacturing cost, etc. In view of those limitations, the present disclosure provides a stator disc that uses a substrate to connect and fix the windings disposed thereon, according to the need of the power and current phase quantity, to realize the connections between the winding coils. The design disclosed herein simplifies the process, reduces the manufacturing cost, avoids overlap between the connecting wires and coils, occurred in conventional coil-winding methods, and thus reducing thickness of the stator disc and ensuring its flatness. At the same time, within a limited area on the disclosed stator disc, the wire diameters of the winding coils may be increased, the turns of the winding coils may be increased, and the number of substrates equipped with multiple windings may be increased, thereby improving power and power density of the motor and the generator, and avoiding the limitations of conventional PCB stator discs, such as small wire diameters and small power.

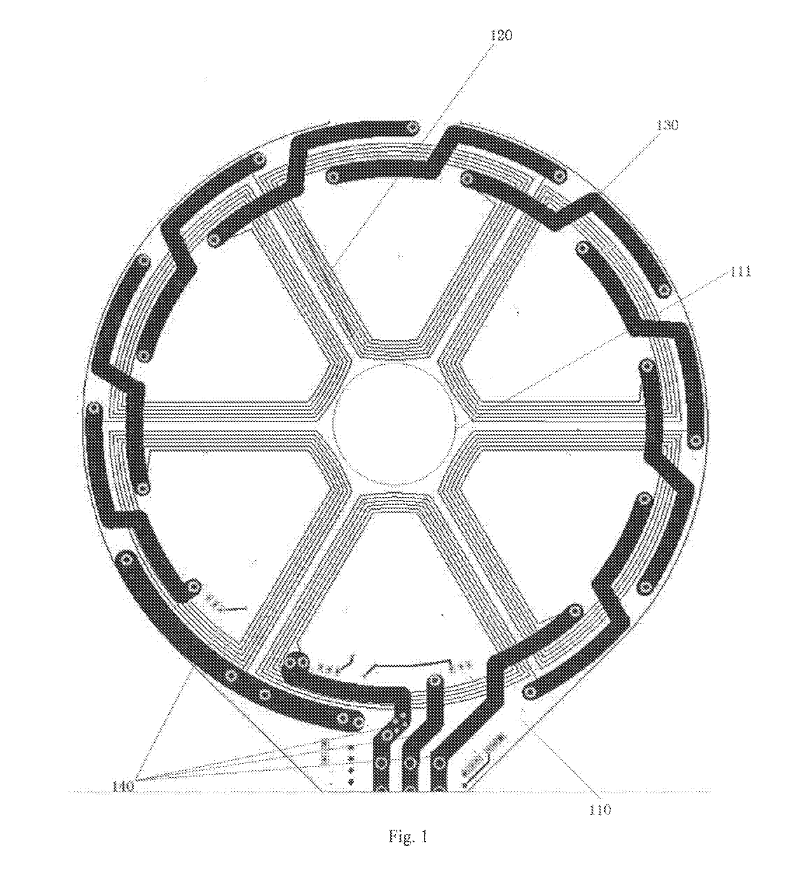

FIG. 1 shows a schematic view of a stator disc according to one embodiment of this disclosure. In this embodiment, the stator disc includes a substrate (110), a plurality of windings (120), at least one connecting conductor (130), and an electric current-terminal connection conductor (140). Substrate (110) has an axle hole (111). Connecting conductor (130) is formed in the substrate (110). All or some of windings (120) are independent of one another and are located on the substrate (110). Windings (120) independent from each other are all or partially connected through connecting conductor (130). Current-terminal connection conductor (140) is formed in the substrate (110) to connect windings (120) to a phase current.

The disclosed stator disc uses a substrate to fix the windings and connect all or some of the windings through conductors in the substrate. This design simplifies the manufacturing process, reduces the manufacturing cost, avoids overlap between the windings, and effectively reduces thickness of the stator disc and ensures the flatness of the stator disc.

In some embodiments of this disclosure, the connecting conductor may be formed in the substrate by (but not limited to) the following ways:
(1) Processing the conductor according to design requirements, and then embedding or arranging the conductor in the substrate; or
(2) If a PCB is used as a substrate, forming in the substrate the connecting conductor pattern as designed.

If the above-stated substrate in (2) is used, because PCB processing is easier, and the production efficiency and processing stability may be further improved.

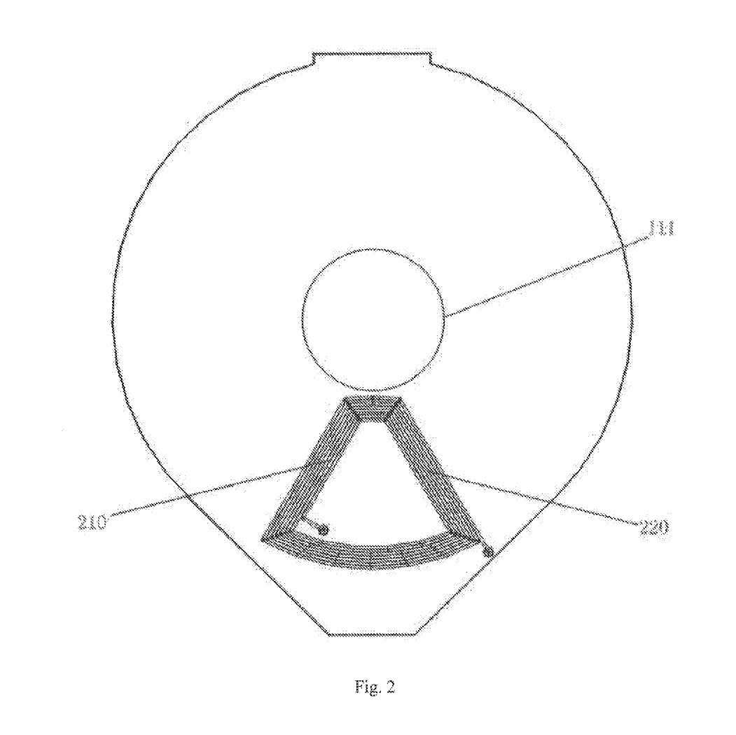

FIG. 2 shows a schematic view of a winding according to one embodiment of this disclosure.

In this embodiment of the disclosure, the winding in the stator disc includes: a first winding side (210) and a second winding side (220), both of which are laid out in a radial direction along an axle hole (111). In this embodiment, the first and second winding sides in a radial direction along the axle hole are referred to as effective sides functioning effectively in the stator disc. For example, the winding may be in a fan shape or be wound to be a roughly an ellipse or a square, but they all have functional effective winding sides that are laid out in a radial direction along the axle hole, and perpendicular to a magnetic field direction. For example, in an application field of an electric motor, when the winding is electrified, a magnetic field may produce a torque centered in the axle hole to drive the rotor of the motor to rotate and start the motor. In an application field of a power generator, when the permanent magnet rotor rotates, rotating magnetic flux linkage cross-linked with the winding coil is generated and thereby an electrodynamic potential is inducted in the winding coil.

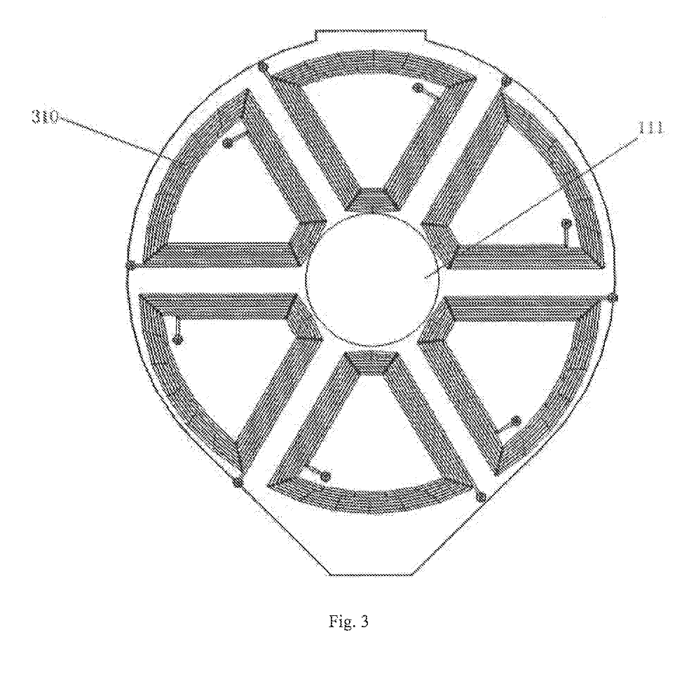

FIG. 3 shows a schematic view of a stator disc according to another embodiment of the present disclosure.

In this embodiment of the disclosure, the windings (310) are laid out in radiation around axle hole (111), which may increase effective working areas of the windings, while avoiding overlap of the windings and avoiding interference and crossing of different phases of current. This arrangement further reduces thickness of the stator disc and ensures flatness of the stator disc.

In this embodiment of the present disclosure, the multiple windings are multiple independent coils. The coils each may be processed independently, which may simplify the processing, avoid difficulty in continuous coil enwinding in the conventional technology, improve the production efficiency, and ensure processing quality. Further, under the premise of ensuring the electric characteristics, it may also reduce mutual interference between various phases of electric currents, avoid overlap of the windings, and effectively reduce thickness of the stator disc and ensure flatness of the disc.

In this embodiment, the winding coils may be adjusted according to power requirements. In a large-power motor, the wire diameter of the winding coil and the number of turns of the windings may be increased, thus improving power and power density of the motor, enhancing its efficiency, and expanding its range of application. Preferably, in this embodiment, the wire diameter of the windings is 0.25 to 1.5 mm, and the total number of winding turns for each current phase is 16 to 70 turns.

In one embodiment of the disclosure, the substrate is single-sided, and the windings are disposed on one side of the substrate.

In one embodiment of the disclosure, the substrate is double-sided, and the windings are disposed on both sides of the substrate respectively.

In one embodiment of the present disclosure, when the substrate is double-sided, the substrate includes: first via holes connected to the connecting conductors, and second via holes connected to the current-terminal connection conductors, to connect all or some of the windings on the substrate. By the first and the second via holes, all or some of the winding coils on both sides of the substrate are connected together, to make full use of the space of the substrate and improve the power density.

In one embodiment of the disclosure, in order to achieve higher power use requirements, the stator disc includes two or more substrates that are arranged in an overlaying mode. In this way, more windings may be installed and fixed on these substrates, and larger power may be output in operation to meet configuration requirements for a larger-power motor.

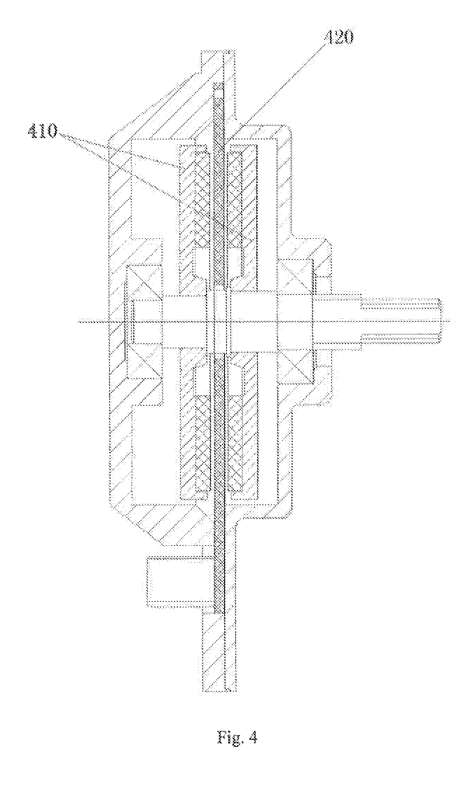

FIG. 4 shows an axial-flux permanent magnet apparatus according to one embodiment of the present disclosure.

In this embodiment of the disclosure, the axial-flux permanent magnet apparatus includes: multiple rotors (410) each having a plurality of permanent magnetic poles and any stator disc (420) as disclosed in the above embodiments. The stator disc structure is the same as that described above, which is not repeated here.

In this embodiment of the disclosure, the rotors are located on both sides of the stator disc, respectively, so that the field directions of the permanent magnetic poles of the rotors are perpendicular to the stator disc. If the axial-flux permanent magnet apparatus is used in the field of an electric motor, Lorentz force is generated to drive the rotor to rotate and start the motor when the stator disc is electrified. If the axial-flux permanent magnet apparatus is used in the field of a power generator, when the permanent magnet rotor rotates, rotating magnetic flux linkage cross-linked with the winding coils may be generated, and then an electrodynamic potential may be inducted in the winding coils.

In this embodiment of the disclosure, the axial-flux permanent magnet apparatus is 50 to 5000 watts in power.

Taking a disc-type permanent-magnetic brushless DC (direct current) motor as an example: the prototype structure and size are determined according to given conditions, related parameters such as air gap, thickness of magnet yoke, and pole arc coefficient, etc. are selected according to engineering design requirements and electromagnetic analysis results; related magnetic intensity and magnetic flux values are obtained based on electromagnetic analysis of a static magnetic field; a no-load back-electromotive force (BEMF) is selected within a reasonable range in view of reducing electric current of the stator, improving efficiency of the motor, reducing motor temperature rise, and also considering a ratio to a rated voltage; a number of turns of the windings for each current phase are calculated based on a BEMF formula, and a final number of the winding turns and a back-electromotive force are determined upon considering a selection of a number of winding coils; a wire diameter and a number of winding turns are determined based on comprehensive consideration of power density, electric load, thermal load, and coil space factor, etc.; an output power is determined according to potential constant and torque constant; a bearing frictional loss and an air-friction loss of armature are calculated based on empirical coefficient, and a copper loss is calculated based on electric current and resistance; the efficiency is then calculated finally. The stator disc and prototype are manufactured and the efficiency is verified according to a series of determined parameters.

The followings are the specific parameters of the 50 watts and 1200 watts disc-type permanent magnet brushless DC motors designed using in the methods described above, the motors having the stator discs provided in the above embodiments:

| | | | | | Total | Total | |
|---|---|---|---|---|---|---|---|
| | | | | Bare wire | turns for | number of | |
| Rated | Rated | Rated | Pole pair | diameter | each | windings for | |
| power | speed | voltage | number | of winding | phase | all 3 phases | Layout mode |
| 50 W | 8000 rpm/min | 18 V | 2 pairs | 0.38 mm | 28 turns | 6 | Distributed on |
| | | | | | | | both sides; 2 |
| | | | | | | | windings for each |
| | | | | | | | phase are |
| | | | | | | | respectively |
| | | | | | | | distributed on the |
| | | | | | | | front and back |
| | | | | | | | sides of the |
| | | | | | | | substrate, forming |
| | | | | | | | a mechanical |
| | | | | | | | angle of 180°; a |
| | | | | | | | total of 3 windings |
| | | | | | | | are evenly |
| | | | | | | | distributed on |
| | | | | | | | each side of the |
| | | | | | | | substrate, forming |
| | | | | | | | a mechanical |
| | | | | | | | angle of 120°. |
| 1200 W | 3600 rpm/min | 36 V | 4 pairs | 1.4 mm | 16 turns | 12 | Distributed on |
| | | | | | | | both sides; 4 |
| | | | | | | | windings for each |
| | | | | | | | phase are |
| | | | | | | | respectively |
| | | | | | | | distributed on |
| | | | | | | | front and back |
| | | | | | | | sides of the |
| | | | | | | | substrate, forming |
| | | | | | | | a mechanical |
| | | | | | | | angle of 90°; a |
| | | | | | | | total of 6 windings |
| | | | | | | | are evenly |
| | | | | | | | distributed on |
| | | | | | | | each side of the |
| | | | | | | | substrate, forming |
| | | | | | | | a mechanical |
| | | | | | | | angle of 60°. |

Taking a disc-type power generator as an example: this disc-type coreless permanent magnet synchronous generator is equipped with the stator disc as described in the embodiments above, and uses an intermediate stator structure, namely, the motor has two rotors and a single stator to form double air gaps. The armature winding is distributed in a radial direction, and active conductors are located on a front surface of the permanent magnet. When the permanent magnet is dragged by the prime mover to a synchronous speed, rotating magnetic flux linkage cross-linked with the armature winding may be generated in the air gaps, inducing 3-phase AC electric potential in the armature winding.

After parameters such as main motor dimensions, winding data, no-load effective flux, internal magnetic induction intensity in the magnet, etc. are determined, and in consideration of factors such as power density, electrical load, and whether a space of the stator disc can hold armature windings, etc., the armature winding of the generator uses enameled round copper wire with bare wire diameter of 0.9 mm, each current phase having 6 windings and 66 turns in total, a total of 18 coils being distributed on two sides of the disc with 9 coils on each side. A generator equipped with the stator disc as disclosed above may reach a power of 5000 watts and a speed of 3600 rpm/min.

To describe this disclosure more clearly, it will be further explained below in combination with the following embodiments. An electric motor is used as examples, but it is not intended to limit this disclosure. Anyone with ordinary knowledge in this technical field may, with an understanding of the embodiments of this disclosure, use it in a power generator after making slight modifications, which are also embodiments of this disclosure, and are not described here.

### Embodiment 1

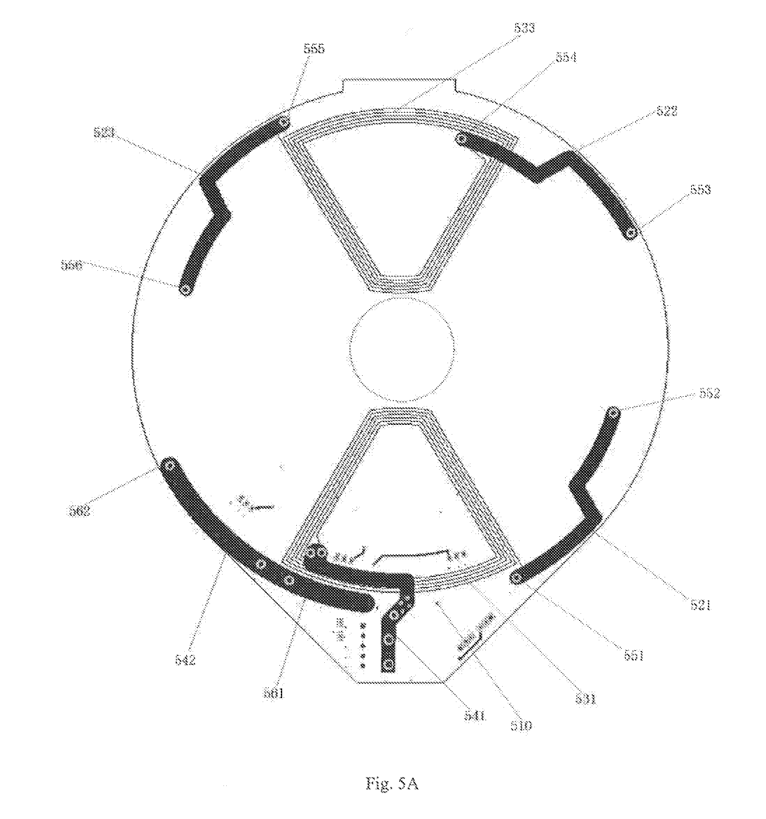

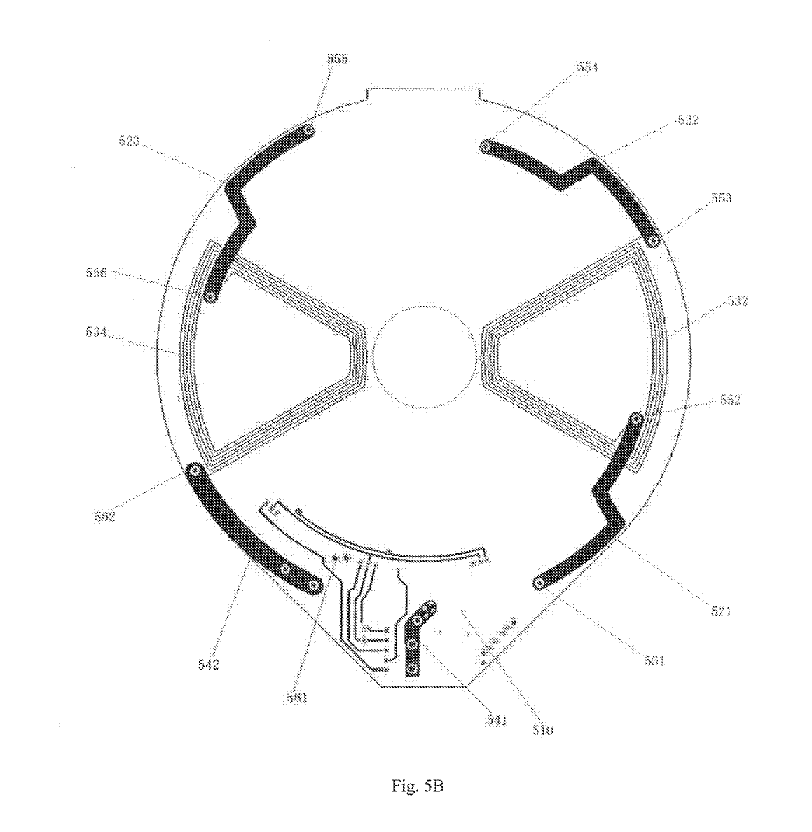

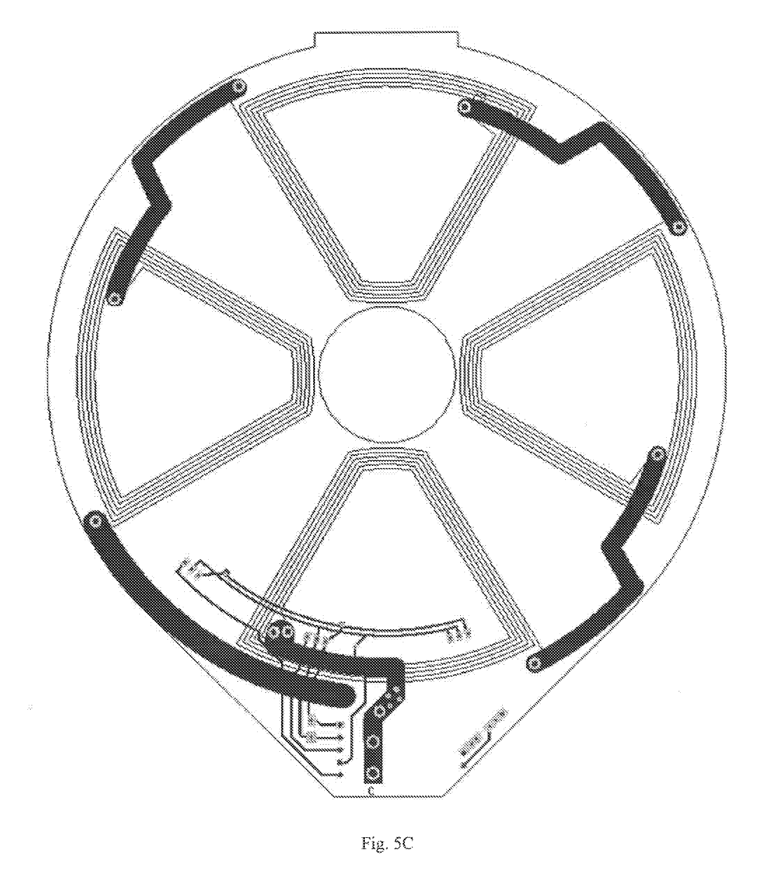

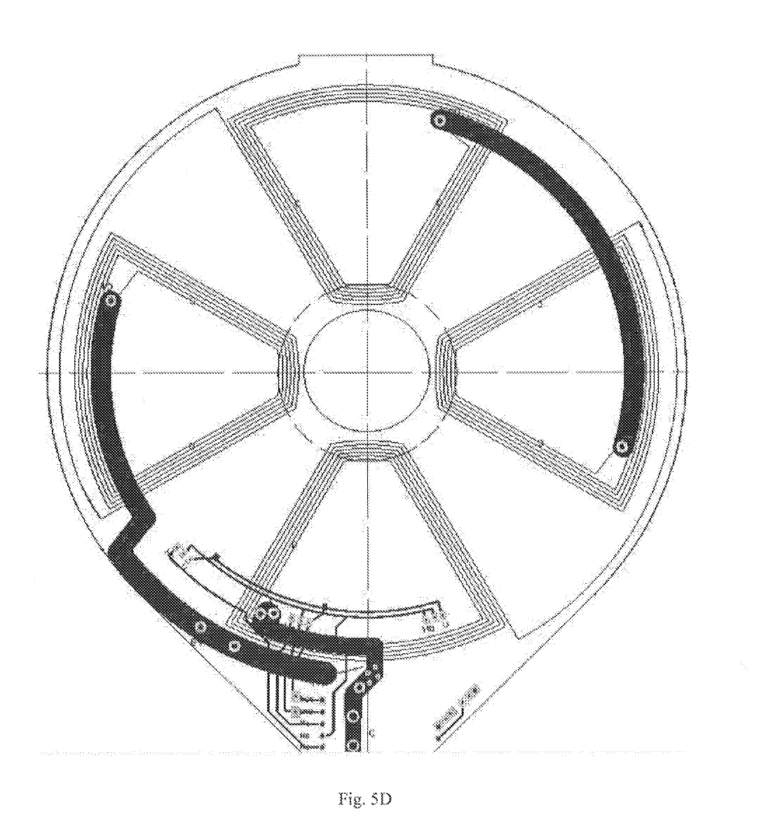

FIGS. 5A and 5B show installation of single-current-phase windings on a circuit board according to one embodiment of this disclosure.

A stator disc applicable for a single-phase current, comprises: a substrate (510) (in this embodiment, substrate 510 is double-sided, windings are respectively disposed on both sides of the substrate, the substrate has an axel hole that is used to insert a shaft); a first connecting conductor (521), a second connecting conductor (522), and a third connecting conductor (523) are formed in the substrate (510); a current-input-terminal connection conductor (541) and a current-output-terminal connection conductor (542) are formed in substrate (510) and used to connect a single-phase current.

First connecting conductor (521), second connecting conductor (522), and third connecting conductors (523) are connected to 6 via holes in the substrate respectively: 551, 552, 553, 554, 555, and 556. The current-terminal connection conductors (541, 542) are connected to a current-input terminal via hole (561) and a current-output terminal via hole (562), respectively.

In this embodiment, four windings (531, 532, 533, and 534) are provided on both sides of substrate (510), respectively. As shown in FIG. 5A, first winding (531) and third winding (533) are provided on a front side of substrate (510). As shown in FIG. 5B, second winding (532) and fourth winding (534) are provided on a back side of the substrate. Each winding has two connection ends, and the windings are connected together through connecting conductors and via holes. When an electric current is switched on, it flows from current-input-terminal connection conductor (541), through current-input-terminal via hole (561), to one connection end of first winding (531). The electric current continues from the other connection end of first winding (531), through first via hole (551), and to first connecting conductor (521). First connecting conductor (521) is connected, through second via hole (552), to one end of second winding (532) on the back side of substrate (510), and is connected, through the other end of second winding (532) and third via hole (553), to second connecting conductor (522). Second connecting conductor (522) is connected, through fourth via hole (554), to one end of the third winding (533) located on the front side of the substrate (510), and is connected through the other end of third winding (533) and fifth via hole (555), to third connecting conductor (523). Third connecting conductor (523) is connected, through sixth via hole (556), to one end of fourth winding (534) located on the back side of substrate (510). The other end of fourth winding (534) is connected, through current-output-terminal via hole (562), to current-output-terminal connecting conductor (542). Thus, as sequentially connected as above, an electric current circuit is formed.

When an electric current is turned on, there will be a continuous electric current flowing through the four windings. Under the influence of perpendicular electromagnetic field, a magneto-motive force rotating around the axle hole would be generated to drive the rotor to rotate.

In another embodiment of the present disclosure, four windings may be provided on one side of the substrate and are connected through three connecting conductors, as shown in FIG. 5C. The details are not described here.

In another embodiment of the present disclosure, four windings may be provided on one side of the substrate and are connected through one connecting conductor, as shown in FIG. 5D. The details are not described here. The dotted line in the figure does not mean anything.

### Embodiment 2

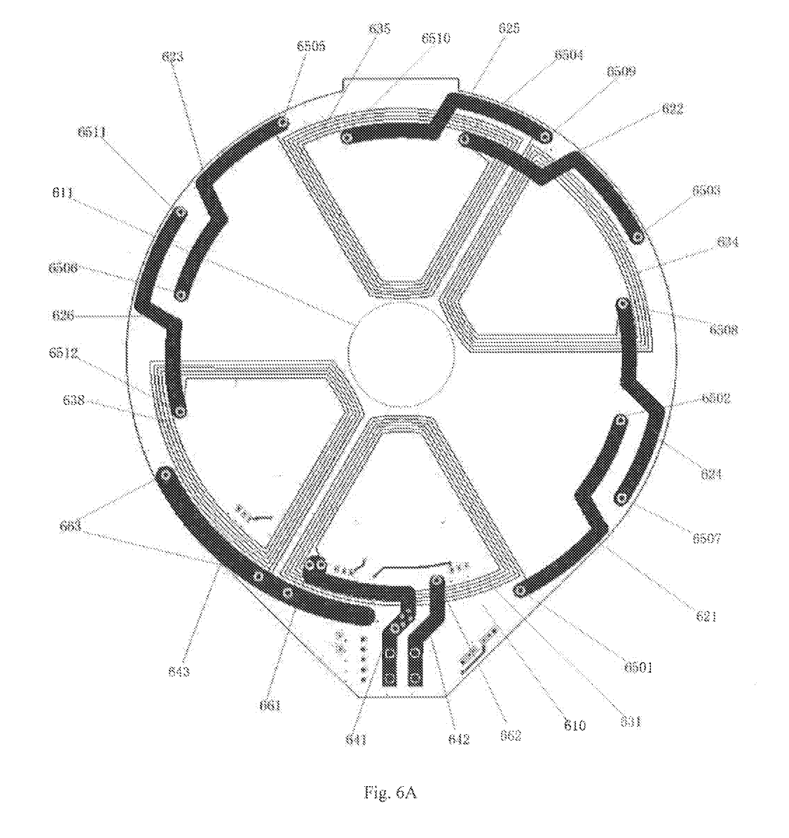

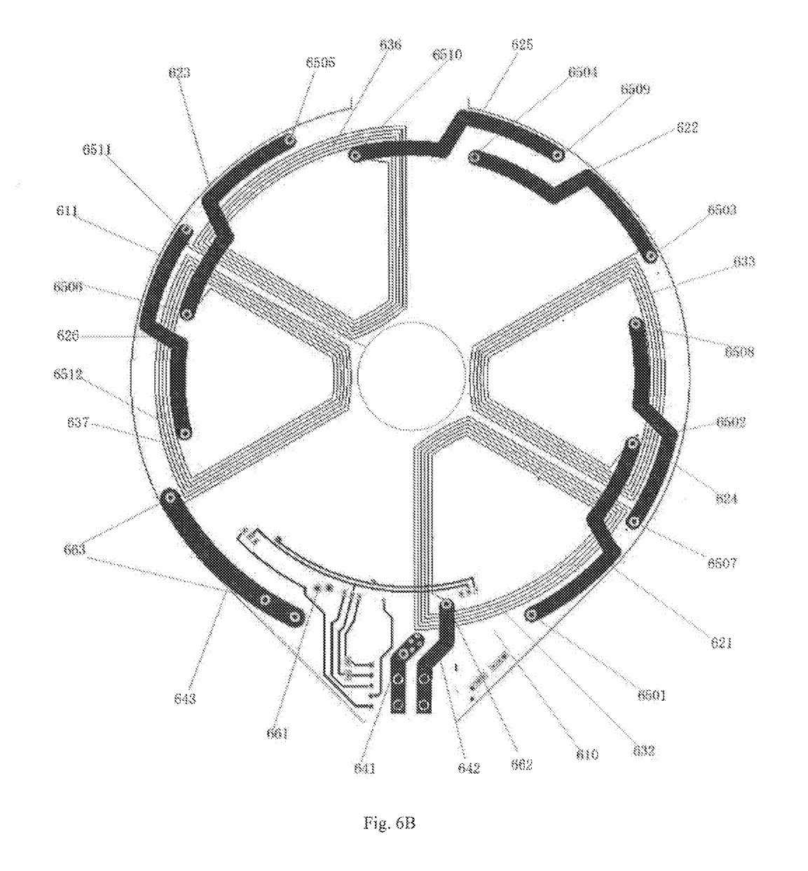

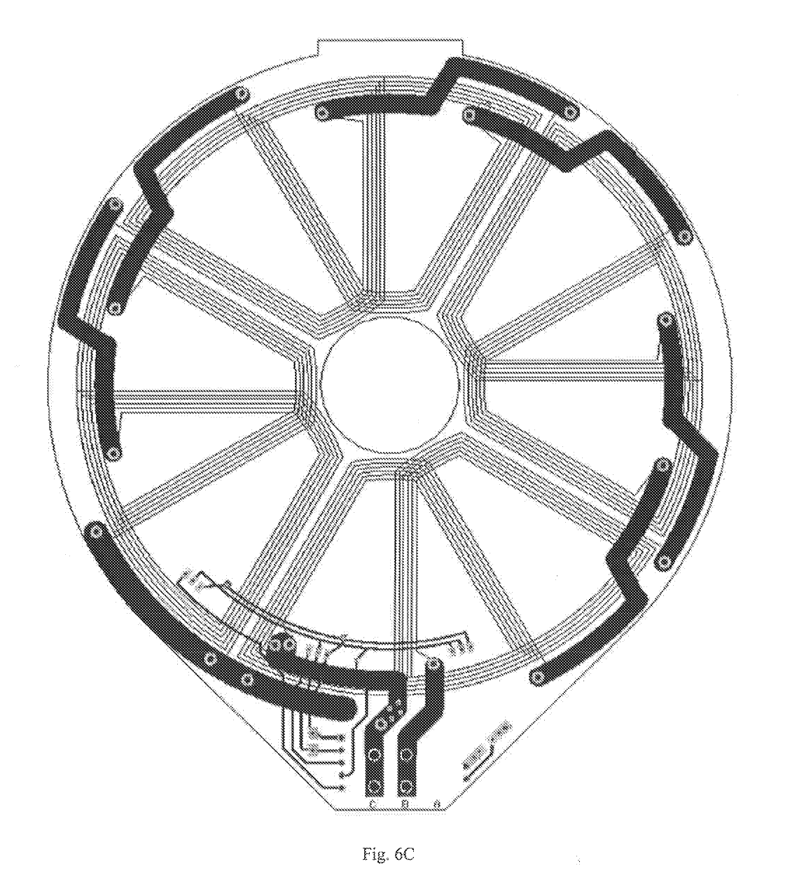

FIGS. 6A and 6B show installation of a two-current-phase winding on a circuit board according to one embodiment of this disclosure.

The stator disc, applicable for two-phase currents, comprises: substrate (610) (in this embodiment, substrate 610 is double-sided, and 8 windings are provided on the both sides of the substrate, respectively; the substrate includes an axel hole 611 that is used to insert a shaft); six connecting conductors (621, 622, 623, 624, 625, and 626) formed in the substrate (610); and 12 via holes (6501-6512) passing through substrate 610 and connected to the six connecting conductors; four windings (631, 634, 635, and 638) provided on the front side of substrate 610; and four winding (632, 633, 636, and 637) provided on the back side of the substrate. Each winding has two connection ends, and the windings are connected together through the connecting conductors and via holes. Current-input-terminal connecting conductors (641 and 642) of the first and second current phases and a current-output-terminal connecting conductor (643) are formed in the substrate, and are connected to current-input-terminal via holes (661 and 662) of the first and second current phases and a current-output-terminal via hole (663) to connect to a respective phase current.

When the two-phase currents are switched on, the first-phase electric current flows from current-input terminal connecting conductor (641) of the first-phase current, through current-input-terminal via hole (661) of the first-phase current, to one connection end of first winding (631). The first-phase current flows through the other connection end of the first winding (631), which is connected, through first via hole (6501), to first connecting conductor (621). First connecting conductor (621) is connected, through second via hole (6502), to one connection end of second winding (633) located on the back side of the substrate (610), and is connected, through the other connection end of second winding (633) and third via hole (6503), to second connecting conductor (622). Second connecting conductor (622) is connected, through fourth via hole (6504), to one connection end of third winding (635) located on the front side of substrate (610), and is connected, through the other connection end of third winding (635) and fifth via hole (6505), to third connecting conductor (623). Third connecting conductor (623) is connected, through sixth via hole (6506), to one connection end of fourth winding (637) located on the back side of substrate (610). The other connection end of fourth winding (637) is connected, through current-output-terminal via hole (663), to current-output-terminal connecting conductor (643). Thus, sequentially connected as the above, an electric current circuit is formed.

The second-phase electric current flows from input-terminal connecting conductor (642) of the second-phase current, through input-terminal via hole (662) of the second-phase current, to one connection end of fifth winding (632) located on the back side of substrate (610). Through the other connection end of fifth winding (632), the current flows to seventh via hole (6507) and then fourth connecting conductor (642). Fourth connecting conductor (642) is connected, through eighth via hole (6508), to one connection end of sixth winding (634) located on the front side of substrate (610), and is then connected, through from the other connection end of sixth winding (634) and ninth via hole (6509), to fifth connecting conductor (625). Fifth connecting conductor (625) is connected, through tenth via hole (6510), to one connection end of seventh winding (636), and is further connected, through the other connection end of seventh winding (636) and eleventh via hole (6511), to sixth connecting conductor (626). Sixth connecting conductor (626) is connected, through twelfth via hole (6512), to one connection end of eighth winding (638) located on the other side of substrate (610). Eighth winding (638) is connected, through current-output-terminal via hole (663), to current-output-terminal connecting conductor (643). Thus, sequentially connect as the above, a current circuit is formed.

When the two phase electric currents are switched on, there will be continuous currents flowing through the eight windings. According to the principle of electromagnetic induction, a magnetic field is generated around the current-carrying conductor. Under the effect of a vertical magnetic field, a magneto-motive force rotating around the axle hole will be generated to drive the rotor to rotate.

In another embodiment of the disclosure, eight windings may be provided on one side of the substrate, as shown in FIG. 6C. The details are not described here.

### Embodiment 3

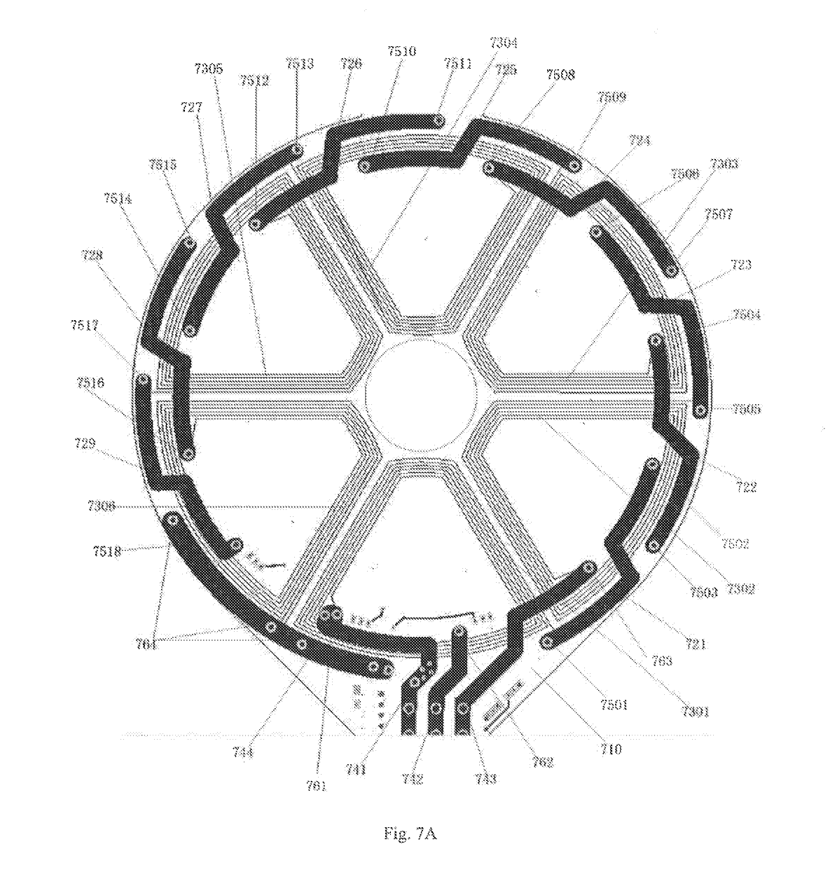

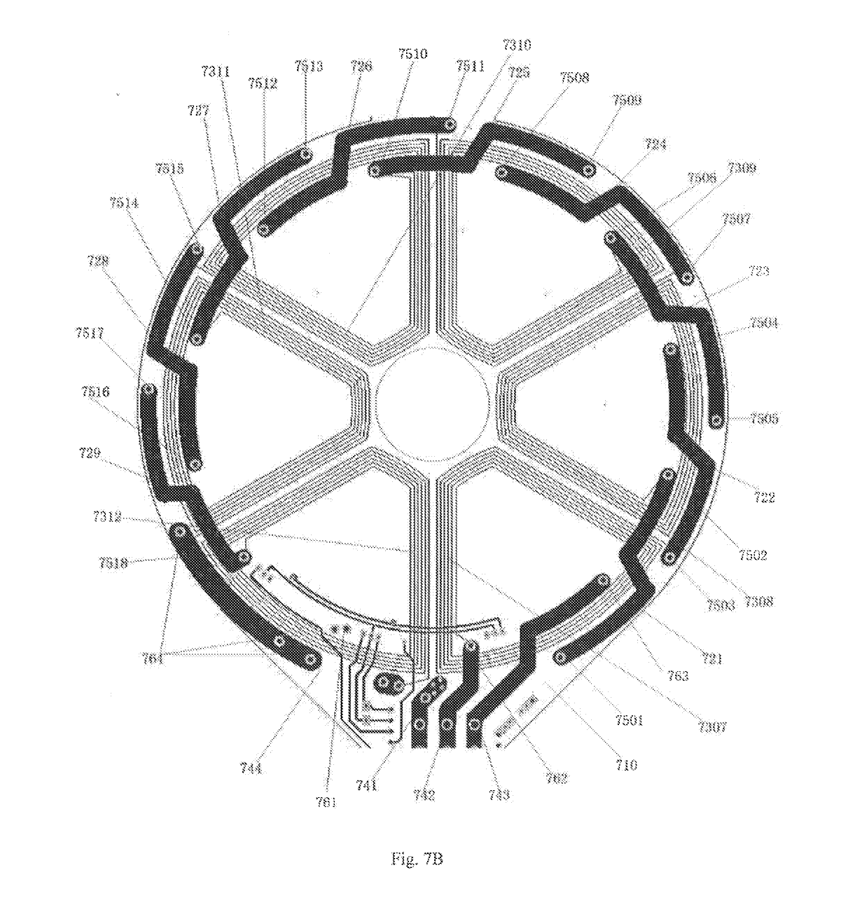

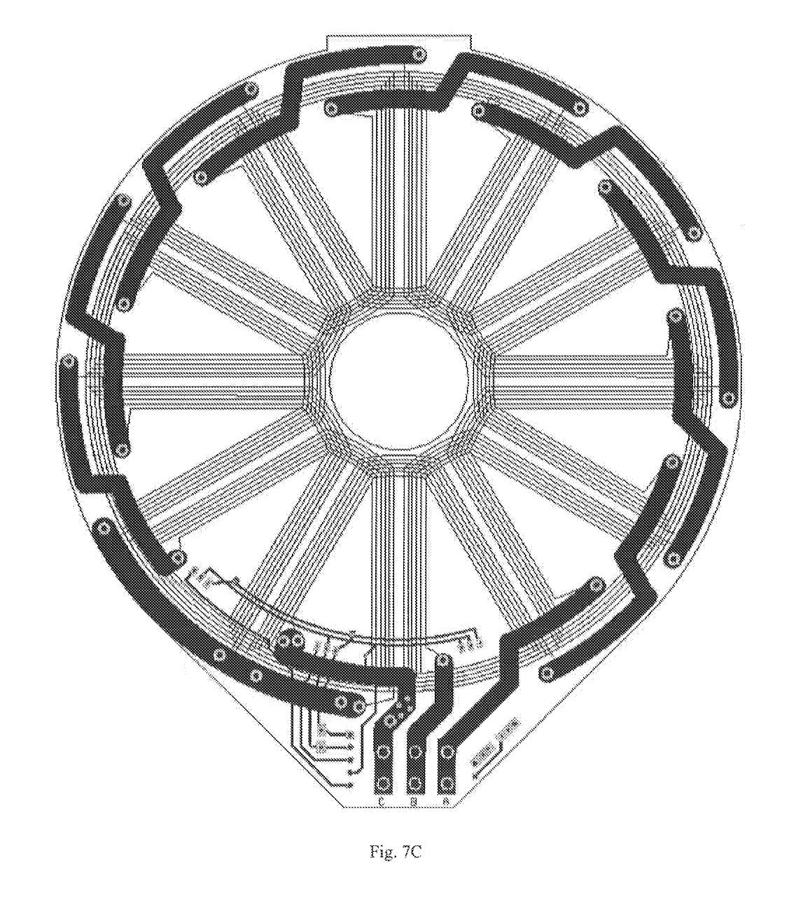

FIGS. 7A and 7B show installation of a three-current-phase winding on a circuit board according to one embodiment of the present disclosure.

In this embodiment, a stator disc, applicable for three-phase currents, comprises: a substrate (710), which is double-sided in this embodiment: 12 windings that may be provided on both sides of the substrate, respectively, the substrate including an axel hole that is used to insert a shaft; and nine connecting conductors (721-729) formed in the substrate (710) and connected to 18 via holes (7501-7518) running through substrate 710. Six windings (7301-7306) are provided on the front side of substrate (710), and the other six windings (7307-7312) are provided on the back side of substrate (710). Each winding has two connection ends, and the windings are connected together through the connecting conductors and via holes. Input terminal connectors (741, 742 and 743) of the first, second, and third phase currents and a current-output-terminal connecting conductor (744) are formed in the substrate, and are connected to input-terminal via holes (761, 762, and 763) of the first, second, and third-phase currents and a current-output-terminal via hole (764) to connect to a respective phase current.

After three-phase currents are turn on, the first-phase electric current flows from input-terminal connecting conductor (741) of the first-phase current, through input-terminal via hole (761) of the first-phase current, to one connection end of first winding (7301). The current continues from the other connection end of first winding (7301), through first via hole (7501), to first connecting conductor (721). First connecting conductor (721) is connected, through second via hole (7502), to one connection end of second winding (7308) located on the back side of substrate (610), and is then connected, through the other connection end of second winding (7308) and third via hole (7507), to second connecting conductor (724). Second connecting conductor (724) is connected, through fourth via hole (7508), to one connection end of third winding (7304) located on the front side of substrate (710), and is then connected, through the other connection end of third winding (7304) and fifth via hole (7513), to third connecting conductor (727). Third connecting conductor (727) is connected, through sixth via hole (7514), to one connection end of fourth winding (7311) located on the back side of substrate (710). The other connection end of fourth winding (7311) is connected, through current-output-terminal via hole (764), to current-output terminal (744). Thus, sequentially connected as the above, a current circuit is formed.

The connections for the second and third-phase currents are similar that as described above, and are not described in detail here.

Each phase current of the three phase currents flows through four single-coil windings, of which two are provided on one side of the substrate and the other two are provided on the other side of the substrate. The four windings on the two sides of the substrate are arranged in a crisscross pattern. The four single-coil windings for each phase are eventually connected, through output-terminal via hole (764), to current-output terminal (744). And the output terminal is a close end of an electric current circuit.

Therefore, when a stator disc of an electric motor is connected to three-phase AC currents, a magnetic field will be generated around an electrified conductor according to the principle of electromagnetic induction. When the three-phase AC currents flow through three-phase current windings of the stator disc, a rotating magnetic field (a rotating magneto-motive force) would be generated in the motor. The rotor's main magnetic pole generated by a permanent magnet would drive the rotor to rotate in a rotating direction of the magnetic field.

In another embodiment of the present disclosure, the 12 windings may be provided on one side of the substrate, as shown in FIG. 7C. The details are not described here.

In sum, the stator disc and axial-flux permanent magnet apparatus provided by the embodiments of the present disclosure has the following advantages:

First, the windings used in the stator disc are each an independent single-coil winding. It is not necessary to wind several coils continuously, and simplifies the processing procedures and improves the production efficiency. The substrate used to fix and connect the winding adopts a simple single-sided or double-sided design with lower cost, and connecting conductors are formed in the substrate. Welding multiple single-coil windings, components, and sockets connected to controllers, etc. simplifies the installation process.

Second, utilizing a substrate to connect, install, and fix the windings and to install and connect other electronic elements and connectors avoids overlap between connecting wires and the coil windings occurred in conventional coil enwinding methods. It reduces thickness of the stator disc and ensures its flatness. By adopting the approach of providing the coil windings on both sides of the substrate, it can also avoid current interferences caused by overlap between the winding coils and improve the electric characteristics greatly.

Third, by increasing the wire diameter of the winding coils or the number of substrates that are equipped with multiple windings, it can enhance the power, power density, and efficiency of the motor greatly.

This invention is disclosed through the above embodiments, but the embodiments are not intended to limit the invention. One with an ordinary skill in the art may make changes or modifications, without departing from the spirit and scope of this invention. The protection scope of this invention is defined by the claims.

1. A stator disc, comprising:
a substrate;
a plurality of windings;
at least one connecting conductor; and
at least one current-terminal connection conductor,
wherein:
the substrate includes an axle hole;
the at least one connecting conductor is formed in the substrate;
all or some of the plurality of windings are independent signal-coil windings and located on the substrate, all or some of the independent single-coil windings are connected together through the at least one connecting conductor; and
the at least one current-terminal connection conductor is formed in the substrate to connect one of the plurality of the windings to a phase current.

2. The stator disc of claim 1, further comprising: a first winding side and a second winding side, which are laid out in a radial direction around the axle hole.

3. The stator disc of claim 1, wherein: the plurality of windings are arranged in radiation around the axle hole.

4. The stator disc of claim 1, wherein: the plurality of windings are independent or partially independent coils.

5. The stator disc of claim 4, wherein: the coils are 0.25-1.5 mm in wire diameter, and a number of windings turns for each current phase is 16-70 turns in total.

6. The stator disc of claim 1, wherein: the substrate is single-sided, and the plurality of windings are located on one side of the substrate.

7. The stator disc of claim 1, wherein: the substrate is double-sided, some of the plurality of windings are located on one side of the substrate, and the rest of the plurality of windings are located on the one side of the substrate.

8. The stator disc of claim 1, wherein the substrate comprises:
a first via hole running through the substrate and connecting with the at least one connecting conductor; and
a second via hole running through the substrate and connecting with the at least one current-terminal connection conductor,
the first and second via holes being used to connect all or some of the plurality of windings on the substrate.

9. The stator disc of claim 1, wherein the substrate comprises two or more substrates that are arranged in an overlaying mode.

10. An axial-flux permanent magnet apparatus, comprising:
a plurality of rotors with a plurality of permanent magnetic poles; and
a stator disc comprising:
a substrate;
a plurality of windings;
at least one connecting conductor; and
at least one current-terminal connection conductor,
wherein:
the substrate includes an axle hole;
the at least one connecting conductor is formed in the substrate;
all or some of the plurality of windings are independent and located on the substrate, all or some of the independent windings are connected together through the at least one connecting conductor; and
the at least one current-terminal connection conductor is formed in the substrate to connect one of the plurality of the windings to a phase current.

11. The axial-flux permanent magnet apparatus of claim 10, wherein: the plurality of rotors are provided on both sides of the stator disc so that the permanent magnetic poles have their field directions perpendicular to the stator disc.

12. The axial-flux permanent magnet apparatus of claim 10, wherein: the axial-flux permanent magnet apparatus is 50-5000 watts in power.
